(19) United States
(12) Patent Application Publication
(10) Pub. No.: US 2003/0110608 A1
(43) Pub. Date: Jun. 19, 2003

(54) Pressing kit for substrate or lead frame of a semiconductor packaging

(76) Inventor: Chun-Tsai Yang, Taipei (TW)

Correspondence Address: YANG, Chun-Tsai, PO Box 82-144, TAIPEI, TW

(21) Appl. No.: 10/180,001

(22) Filed: Jun. 24, 2002

(30) Foreign Application Priority Data
Dec. 19, 2001 (TW) 090222628

(51) Int. Cl. B23P 23/00

(52) U.S. Cl. 29/33 M

(57) ABSTRACT

A pressing kit for substrate or lead frame of a semiconductor packaging. The kit comprises a box body and a press block, wherein the box body is a hollow metallic body having a U-shaped lead board at the two lateral sides thereof. The bottom face of the inner side of the U-shaped lead board is provided with a blocking block for the holding of a bottom board. The pressing block is an elongated block body of similar length to the inner side of the box body, and the top face is provided with four pillar holes. The circular slot on the top of the pillar hole is inserted with a screw bolt from the top thereof, and a compression spring is placed at the wider recess at the bottom section.

### BACKGROUND OF THE INVENTION

(a) Field of the Invention

The present invention relates to a pressing kit for substrate or lead frame of a semiconductor, and in particular, a specifically designed kit where a plurality of substrates or lead frame are stacked within the kit and the substrates or the lead frames are subjected to an appropriate uniform pressure and the pressure is maintained throughout the entire ovening process to prevent the substrate or lead frame from forming warpage.

(b) Description of the Prior Art

In the course of semiconductor chip manufacturing process as shown in FIG. 1, the chip packages on the substrate or lead frame are normally consisted of a plurality of chip packages on a same substrate or lead frame. After that the chip package is cut into appropriate sizes. However, in the above manufacturing process, when the chip is mounted onto the substrate 1′ (or lead frame) and is then undergone a molding 2′ process, the substrate 1′ (or lead frame) warps as a result of uneven pressure distribution lines 3′ on the substrate 1′ (or lead frame) which is due to the curing, compression of the chip adhesive (not shown) and chip molding, and the differences in the thermal expansion coefficient of various materials. In the particular, at environment where the area of the naked chip is larger or longer, and under the condition where the thickness of the substrate (or lead frame) being which required low strain packaging film, the coplanarity of the final product cannot be maintained. In view of the above, it is an object of the present invention to provide a pressing kit for substrate or lead frame of a semiconductor packaging which mitigates the above drawbacks.

### SUMMARY OF THE INVENTION

Accordingly, it is an object of the present invention to provide a pressing kit for substrate or lead frame of a semiconductor packaging, wherein the present kit will improve the stability of the coplanarity of large packaging area.

Yet another object of the present invention is to provide a pressing kit for substrate or lead frame of a semiconductor packaging, wherein the thinner substrate (or lead frame) fabricated by the present kit provides a better competition product.

One aspect of the present invention is to provide a pressing kit for substrate or lead frame of a semiconductor packaging comprising a box body and a press block; wherein the box body is a hollow metallic body having a U-shaped lead board at the two lateral sides thereof, the bottom face of the inner side of the U-shaped lead board is, provided with a blocking block for the holding of a bottom board; and the pressing block is an elongated block body of similar length to the inner side of the box body, and the top face is provided with four pillar holes, the circuit slot on the top of the pillar hole is inserted with a screw bolt from the top thereof, a compression spring is placed at the wider recess at the bottom section thereof, the end terminal of the screw bolt is mounted to the screw hole corresponding to the pressing board, and a pair of L-shaped block having one end being connected by screw to the lateral side edge of the elongated block and the other end of the L-shaped block is positioned at the outer side of the end face of the elongated block and a screw hole is provided on the L-shaped block to screw in a rotating button, and a press pad is provided to the end of the screw; thereby the bottom board is positioned on the blocking block of the box body and a heat-resistance buffering pad is placed on the bottom board and a bar-shaped substrate (or lead frame) are stacked on the buffering pad, thereby when the pressure of the pressing device is removed the pressing block is still maintained a pressure on the substrate (or the lead frame), after that the entire box body the pressing block and the substrate (or lead frame) are delivered to the oven, when the rotating screw is loosen, and the substrate (or lead frame) is withdrawn.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the bonding element of the conventional heat sink and substrate (or lead frame).

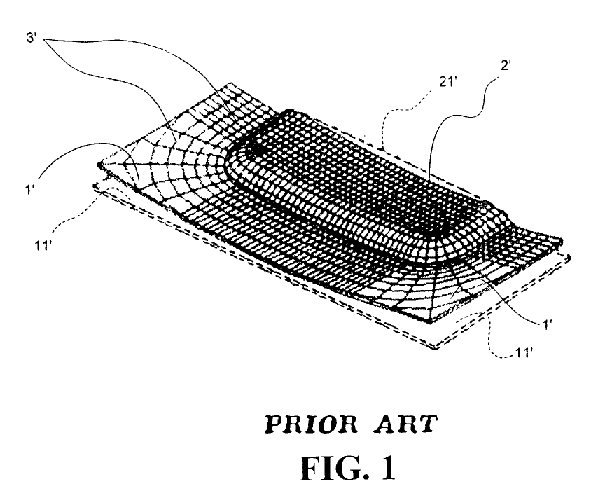

FIG. 2 is a perspective exploded view of a pressing kit for substrate or lead frame of a semiconductor packaging in accordance with the present invention.

FIG. 3 is a perspective view of a pressing kit for substrate or lead frame of a semiconductor packaging in accordance with the present invention.

FIGS. 4A, 4B, 4C, 4D and 4E illustrate the packaging process in accordance with the present invention.

### DETAILED DESCRIPTION OF THE PRESENT INVENTION

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

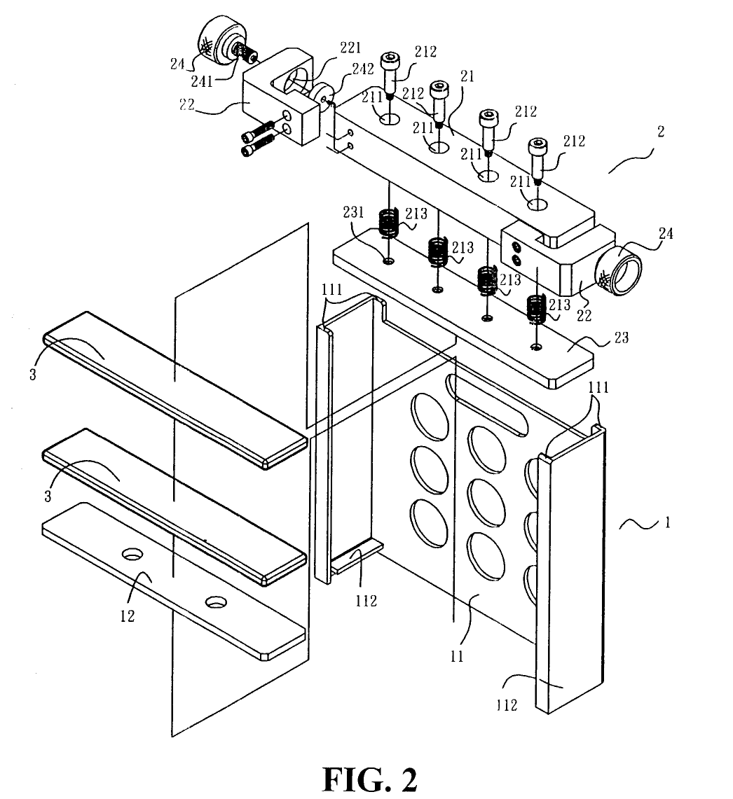

Referring to FIG. 2, there is shown a pressing kit for substrate or lead frame of a semiconductor packaging comprising a box body 1 and a pressing block 2. The box body 1 is a hollow metallic body 11 having a U-shaped lead board 111 at the two lateral sides thereof. The bottom face of the inner side of the U-shaped lead board 111 is provided with a blocking block 112 for the holding of a bottom board 12.

The pressing block 2 is an elongated block body 21 of similar length to the inner side of the box body 1, and the top face is provided with four pillar holes 211. The circular slot on the top of the pillar hole 211 is inserted with a screw bolt 212 from the top thereof, and a compression spring 213 is placed at the wider recess at the bottom section. The end terminal of the screw bolt 212 is mounted to the screw hole 231 corresponding to the pressing board 23. The pressing board 23 and the elongated block 21 are of equal width (but not equal thinness). A pair of L-shaped block 22 having one end being connected by screw to the lateral side edge of the elongated block 21, and the other end of the L-shaped block 22 is positioned at the outer side of the end face of the elongated block 21 and a screw hole 221 is provided on the L-shaped block 22 to screw in a rotating button 24. The rotating button 24 has a handle portion and the end of the screw 241 connecting the rotating button is provided with a press pad 242. After the press pad 242 is connected to the rotating button 24, the press ad 242 can be restricted to the two lateral sides of the screw hole 221 of the L-shaped block 22.

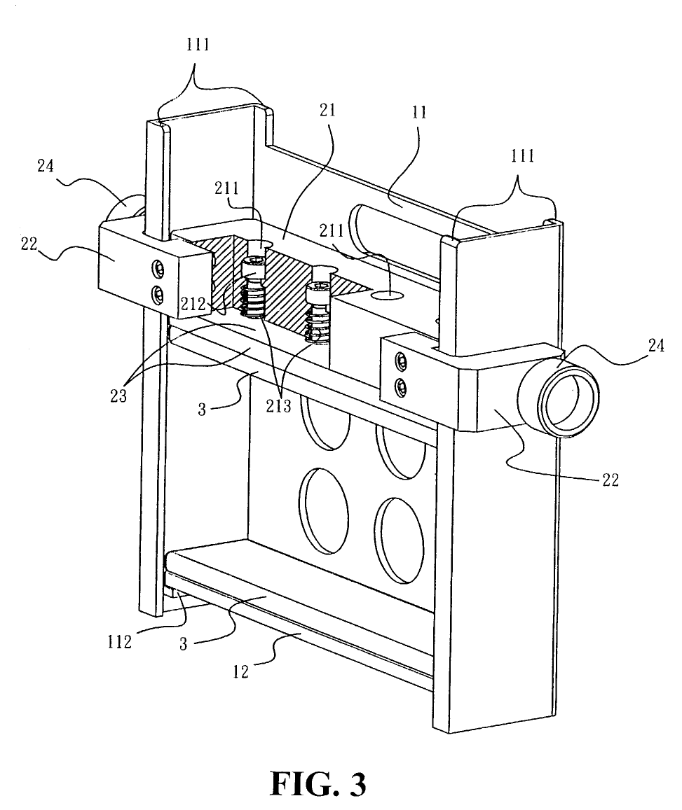

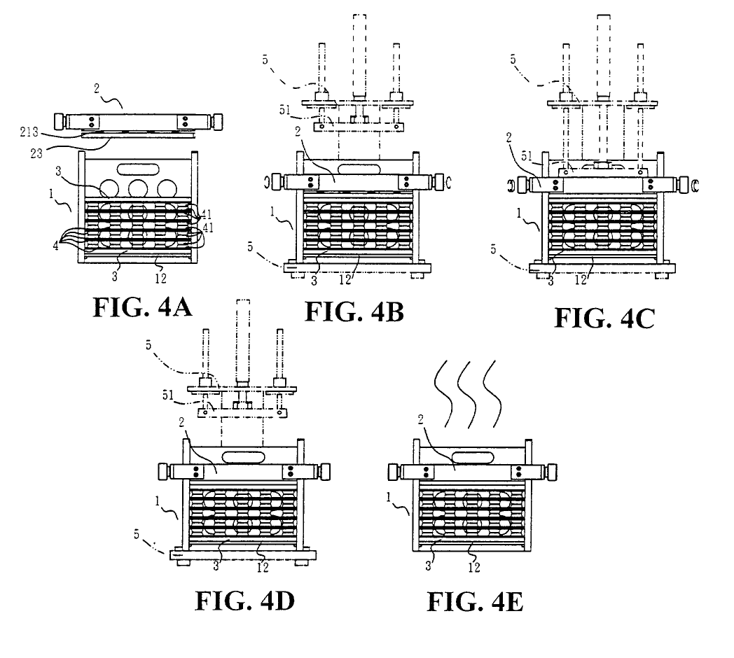

Referring to FIG. 3 and FIGS. 4A-4E, the bottom board 12 is positioned on the blocking block 112 of the box body 1 and a heat-resistant buffering pad 3 is positioned on the bottom board 12. The bar-shaped substrate 4 after mounted with film 41 is stacked, facing each other, on to the heat-resistance buffering pad 3, and the uppermost bar of the substrate 4 (or the lead frame) is placed with a heat-resistance buffering pad 3 (as shown in FIG. 4A). After that a press block 2 is pressed onto the uppermost layer (as shown in FIG. 4B). Then, the rotating button 24 at the two lateral sides is slightly tighten such that the distance between the press block 2 and the lateral face of the box body is shorten, avoiding excessive bias movement when the press block 2 tights the rotating button 24 as a result of pressing, which affect the uniformity of pressure. After that the pressing rod 51 of the pressing device 5 is provided with an appropriate pressure onto the press block 2 such that when the compression spring 213 is compressed the rotating buttons 24 at the two lateral sides are tighten (as shown in FIG. 4C) such that the press block 2 after the pressure of the press rod 51 is removed, still provides a pressure on the substrate 4 (or lead frame) as a result of restoration force of the spring 213 (as shown in FIG. 4D). The entire box body 1 press block 2 and the substrate 4 (or lead frame) are delivered to the oven (as shown in FIG. 4E), when the rotating button 24 is loosen the substrate 4 (or the lead frame) is removed.

By means of the pressing kit and the stacking of the positive side and the reverse side of the substrate 4 (or the lead frame), when a slight pressure is exerted, by means of the substrate 4 (or the lead frame) and the mold 41 thereon, the pressure is transmitted to the substrate 4 (or the lead frame) when a pressure is exerted on the substrate 4 (or the lead frame), a heat-resistance buffering pad 3 provides a buffering function to evenly distribute the pressure. Thus, the number and the material of the heat resistance buffering pad 3 can be changed appropriately when required.

When the substrate (or lead frame) being undergone a heat-ovening process is subjected to an appropriate pressure, the strain of the substrate (or the lead frame) can be released, this will reduce the possibility of warpage.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A pressing kit for substrate or lead frame of a semiconductor packaging comprising:
a box body and a press block; wherein the box body is a hollow metallic body having a U-shaped lead board at the two lateral sides thereof, the bottom face of the inner side of the U-shaped lead board is provided with a blocking block for the holding of a bottom board; and the pressing block is an elongated block body of similar length to the inner side of the box body, and the top face is provided with four pillar holes, the circuit slot on the top of the pillar hole is inserted with a screw bolt from the top thereof, a compression spring is placed at the wider recess at the bottom section thereof, the end terminal of the screw bolt is mounted to the screw hole corresponding to the pressing board, and a pair of L-shaped block having one end being connected by screw to the lateral side edge of the elongated block and the other end of the L-shaped block is positioned at the outer side of the end face of the elongated block and a screw hole is provided on the L-shaped block to screw in a rotating button, and a press pad is provided to the end of the screw;
thereby the bottom board is positioned on the blocking block of the box body and a heat-resistance buffering pad is placed on the bottom board and a bar-shaped substrate (or lead frame) are stacked on the buffering pad, thereby when the pressure of the pressing device is removed the pressing block is still maintained a pressure on the substrate (or the lead frame), after that the entire box body the pressing block and the substrate (or lead frame) are delivered to the oven, when the rotating screw is loosen, and the substrate (or lead frame) is withdrawn.

2. The pressing kit of claim 1, wherein the heat-resistant pad is metallic or other material.
